(19) United States
(12) Patent Application Publication
(10) Pub. No.: US 2006/0184344 A1
(43) Pub. Date: Aug. 17, 2006

(54) Simulator and simulation method using programming language interface of hardware description language

(75) Inventor: Jae-Young Heo, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/351,673

(22) Filed: Feb. 10, 2006

(30) Foreign Application Priority Data
Feb. 11, 2005 (KR) 11690/2005

(51) Int. Cl. G06G 7/48

(52) U.S. Cl. 703/4

(57) ABSTRACT

A simulator using a hardware description language programming language interface and a simulation method thereof, in which an electronic characteristic of an analogue circuit is coded into a program language of a programming language interface thereby to be interfaced. The simulator using a hardware description language programming language interface comprises: a program memory for storing a simulation program to perform a simulation by interfacing a digital circuit block and an analogue circuit block; and a data memory for storing an inner parameter generated as the simulation program is executed, in which the simulation program comprises a program language interface of a hardware description language for supporting a programming language interface, and an analogue circuit block implemented as a hardware transfer function, an electronic characteristic of an analogue circuit is coded into a program language interface.

Pursuant to 35 U.S.C. § 119(a), this application claims the benefit of earlier filing date and right of priority to Korean Patent Application No. 11690/2005, filed on Feb. 11, 2005, the content of which is hereby incorporated by reference herein in its entirety.

### BACKGROUND OF THE INVENTION

1. Field of the Invention

The present invention relates to a simulator and a simulation method using a programming language interface of a hardware description language.

2. Description of the Background Art

Recently, an integration level for producing an integrated circuit is being enhanced, a size of a device is being decreased, and a complexity of a circuit construction is being increased, which results in a long circuit design time. The circuit design is performed by designing an analogue circuit block by using a digital design tool and an analogue design tool and by performing a circuit verification through a simulation.

The digital design tool uses a hardware description language (HDL) and is suitable for a digital circuit design due to a fast velocity. However, the digital design tool is not suitable for an analogue circuit. As an analogue circuit design tool, an upper level simulation tool such as Matlab Simulink is used. The analogue circuit design tool performs a behavioral level simulation. After the behavioral level simulation is completed, a transistor level design is performed based on a result of the behavioral level simulation.

Whereas the behavioral level simulation considers a mathematical characteristic without a load characteristic such as a capacitor or a resistance and an electron circuit characteristic, the transistor level design considers the electron circuit characteristic. Accordingly, the behavioral level simulation is much different from the transistor level design, and thus a designer has a much difficulty in verifying the transistor level design based on a result of the behavioral level simulation. Furthermore, the designer can not directly apply a substantial value calculated from the behavioral level simulation to the transistor level design, but performs a tuning operation by adjusting a capacitor value or a resistance value.

The transistor level design is performed by using a spice tool. The spice tool has a high precision, but it has a long simulation time. Therefore, the designer repeatedly performs a simulation by tuning a component value. As the simulation is repeatedly performed, the spice simulation time is increased thereby to occupy most of the entire design time.

### BRIEF DESCRIPTION OF THE INVENTION

Therefore, an object of the present invention is to provide a simulator using a programming language interface of a hardware description language and a simulation method capable of performing a simulation by coding an electronic characteristic of an analogue circuit into an upper level language, converting the language into a behavioral block by a digital design tool, and thus interfacing the behavioral block with another digital circuit, and capable of outputting a result similar to a transistor level design.

To achieve these and other advantages and in accordance with the purpose of the present invention, as embodied and broadly described herein, there is provided a simulator, comprising: a program memory for storing a simulation program to perform a simulation by interfacing a digital circuit block and an analogue circuit block; and a data memory for storing an inner parameter generated as the simulation program is executed, in which the simulation program comprises a program language interface of a hardware description language for supporting a programming language interface, and an analogue circuit block that a hardware transfer function, an electronic characteristic of an analogue circuit is coded into a program language interface.

To achieve these and other advantages and in accordance with the purpose of the present invention, as embodied and broadly described herein, there is also provided a simulation method, comprising: coding a hardware transfer function of an analogue circuit block interconnected with a sub block coded into a program language interface of a hardware description language into a program language of the program language interface; and reading the analogue circuit block linked to each sub block thereby connecting to each other, and simulating an upper level block composed of the sub block and the analogue circuit block.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing a construction of a simulator using a programming language interface of a hardware description language according to a preferred embodiment of the present invention;

FIG. 2 is an exemplary view showing a design layer of a hardware description language according to the present invention;

FIG. 3 is an exemplary view explaining that a hardware transfer function of an inverting amplifier among analogue circuit blocks is coded into a C language;

FIG. 4 is a flowchart showing an operation for simulating an analogue circuit block coded into a C language by an interface using an HDL PLI in a simulator according to the present invention;

FIG. 5 is an exemplary view explaining an operation for searching an analogue circuit block to be coded into an upper level language between a behavioral level design and a transistor level design;

FIG. 6 is a circuit diagram showing a construction of an inverting amplifier;

FIG. 7 is an exemplary view showing each simulation result by a simulator and an analogue design tool;

FIG. 8 is an exemplary view showing a linked construction of a hardware transfer function library to be coded into a C language in the simulator according to the present invention; and

FIG. 9 is an exemplary view showing a construction of a graphic user interface (GUI) for adjusting a parameter that influences on an electron circuit characteristic included in a hardware transfer function library according to the present invention.

### DETAILED DESCRIPTION OF THE INVENTION

Reference will now be made in detail to the preferred embodiments of the present invention, examples of which are illustrated in the accompanying drawings.

Hereinafter, preferred embodiments of the present invention will be explained with reference to the attached drawings.

FIG. 1 is a block diagram showing a construction of a simulator using a programming language interface of a hardware description language according to a preferred embodiment of the present invention.

In a hardware description language programming language interface (HDL PLI), a linking program coded into a common programming language such as a C language, etc. by the HDL PLI 140 is compiled into one or plural object libraries linked into an HDL system model before a simulation is performed. The HDL defines a name, a function, and substantial parameters of a program language path that is called by user PLI programs for an interaction with an HDL simulator.

For instance, in the HDL PLI 140, a callback is performed so that the HDL simulator can read a user program routine when a specific system task composed into a C language is executed, and a PLI delay routine sets a time delay in a simulator and reads the delayed time.

A simulator 100 according to the present invention interfaces an analogue circuit block implemented as a PLI and a sub block implemented as an HDL by using the HDL PLI 140 thereby to perform a simulation. The HDL PLI 140 supports a standard C interface. The simulator 100 compiles the analogue circuit block composed into a C language of a standard C interface by a C compiler, and thus registers a callback routine, a user program routine, or a PLI delay routine. The simulator 100 parses and compiles a language construct coded into the HDL PLI 140, and thereby calculates a hardware transfer function included in a behavioral block of the analogue circuit, that is, a user program routine when a specific system task is executed.

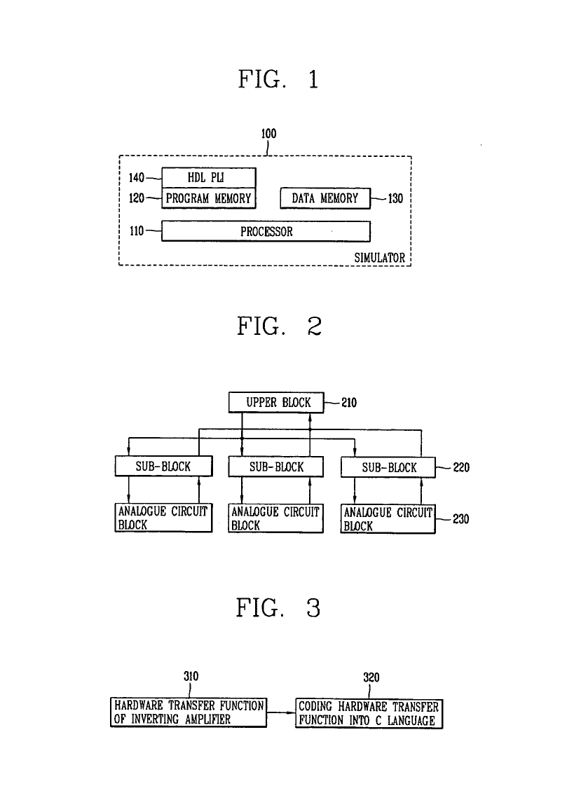

FIG. 2 is an exemplary view showing a design layer of a hardware description language according to the present invention.

A language construct coded into the HDL PLI 140 comprises an upper block 210, a sub block 220, and an analogue circuit block 230. The analogue circuit block 230 describes a hardware transfer function coded into a C language of an analogue circuit, and the sub block 220 describes a language construct coded into the HDL PLI 140 from input/output signals interconnected with the analogue circuit block 230. Also, the upper block 210 describes a language construct coded into the HDL PLI 140 from input/output signals interconnected with the sub block 220.

The analogue circuit block 230 comprises a hardware transfer function coded into a C language. The hardware transfer function shows an electronic characteristic of the analogue circuit. For instance, the analogue circuit comprises an inverting amplifier. The inverting amplifier is the most basic block in designing an analogue circuit, and is the most frequently used.

FIG. 3 is an exemplary view explaining that a hardware transfer function 310 of an inverting amplifier among the analogue circuit blocks is coded into a C language.

The inverting amplifier inverts two input voltages by amplifying as much as a resistance ratio between an input terminal and an output terminal and thereby outputs the voltages. The hardware transfer function 310 of the inverting amplifier can be expressed as follows.
V₀=−(v₁*r₃/r₁+v₂*r₃/r₂)

The hardware transfer function 310 of the inverting amplifier has a resistance value to be applied to a substantial electronic circuit, and an output gain value is determined according to the resistance value. In the analogue circuit block of the inverting amplifier, the hardware transfer function expressed as a formula is coded into a C language.

For instance, a language construct that the hardware transfer function 310 of the inverting amplifier is coded into a C language is as follows.

Int invert_calltf (char*user_data){

double R1, R2, R3, v1, v2, vin, vout;

vout=−(R3/R1)*V1+(R3/R2)v2;

value_s.value.integer=(int) vout;}

The language construct comprises a function declaration, a parameter declaration, a formula technique, and an assignment statement.

The simulator 100 reads the analogue circuit block 230 interconnected with the sub block 220 coded into the HDL PLI 140 thereby to connect to each other, and simulates the upper block 210 composed of the sub block 220 and the analogue circuit block 230. The simulator 100 parses and compiles the language construct coded into the HDL PLI 140, thereby registering the analogue circuit block 230 declared as a PLI API library routine into a system task. Then, the simulator 100 calculates the hardware transfer function included in the analogue circuit block 230, that is, a user program routine when the system task is executed. Also, the simulator 100 inputs an arbitrary value varied according to a time lapse to the analogue circuit block 230, and outputs a result value obtained by simulating a variation of the inputted value by the hardware transfer function coded into a C language of the analogue circuit block 230.

The simulator 100 is implemented by a processor that can execute a program to perform a series of processes. For instance, the processor 110 comprises a program memory 120 for storing a simulation program that simulates a digital circuit block and an analogue circuit block by an interfacing, and a data memory 130 for storing an inner parameter according to a program execution. The simulation program comprises the HDL PLI 140 for supporting a standard C interface, the analogue circuit block 230 that a hardware transfer function, an electronic characteristic of an analogue circuit is coded into a C language, a converting unit for converting the hardware transfer function of the analogue circuit into a program language of a hardware description language program language interface (HDI PLI), and a simulation unit for simulating the hardware transfer function of the analogue circuit block converted into the program language.

Hereinafter, an operation of the simulator 100 implemented by the processor 110 for performing a simulation by using the HDL PLI 140 will be explained.

Before explaining the operation of the simulator 100, terms used in the present invention will be defined.

The HDL PLI denotes a hardware description language programming language interface, the PLI API library routine denotes a programming language interface application program interface library routine, the language construct denotes a construction factor necessary to describe a programming language, the system task denotes a task for executing a hardware transfer function declared as the PLI API library routine and coded into a C language, and the user program routine denotes an analogue circuit block coded into a C language in the HDL PLI.

The upper level language denotes a high quality language represented as a C language. Also, the digital circuit block denotes a sub block coded into the HDL PLI and a circuit block coded into an HDL from the upper block.

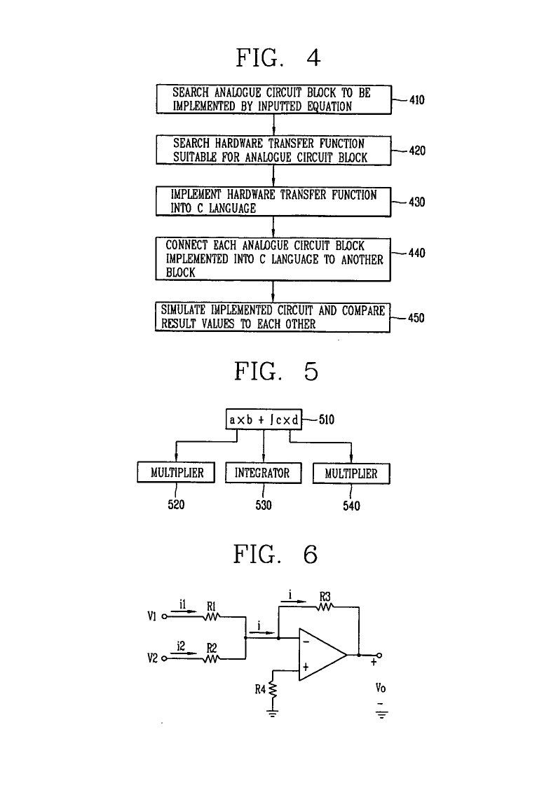

FIG. 4 is a flowchart showing an operation for simulating an analogue circuit block coded into a C language by an interface using an HDL PLI in a simulator according to the present invention.

The simulator codes the analogue circuit block interconnected with the sub block coded into the HDL PLI into a C language, and reads the analogue circuit block from each sub block thereby to connect to each other. Also, the simulator simulates the upper block composed of the sub block and the analogue circuit block. The upper block and the sub block may comprise a digital circuit block.

The simulator receives an equation in a step of designing a behavioral level, and searches an analogue circuit block corresponding to an analogue circuit to be implemented from the inputted equation (410). FIG. 5 is an exemplary view explaining an operation for searching an analogue circuit block to be coded into an upper level language between a behavioral level design and a transistor level design. For example, when an inputted equation is a*b+ [symbol] *d (510), the simulator searches a multiplier 520 analogue circuit block corresponding to the multiplication signal (*) and an integrator 530 analogue circuit block corresponding to the integration signal ( [symbol] . That is, the simulator searches an analogue circuit block to be implemented as an analogue circuit from the inputted equation, and determines an analogue circuit block corresponding to an analogue circuit.

The simulator searches a hardware transfer function suitable for the determined analogue circuit block (420), constitutes the analogue circuit block with the hardware transfer function implemented into a C language (430), and connects each analogue circuit block to a different digital circuit block (440). The simulator codes a hardware transfer function of an analogue circuit block into a C language thereby to constitute an analogue circuit block corresponding to an analogue circuit. Then, the simulator connects the constructed analogue circuit blocks to different digital circuits.

The simulator simulates the digital circuit block coded into an HDL PLI and the analogue circuit block coded into a C language, and outputs a result value (450). The simulator inputs an arbitrary value varied according to a time lapse to the digital circuit block and the analogue circuit block, and then outputs a result value simulated by a hardware transfer function coded into a C language of the analogue circuit block and by a transfer function of the digital circuit block.

The designer compares the result value by the simulator with a result value by an HSPICE thereby to certify that the result values are similar to a transistor level, and verifies an analogue transistor level circuit.

The simulator codes a hardware transfer function corresponding to each analogue circuit block into a C language, and thereby includes an electronic characteristic of each component into each of the analogue circuit blocks coded into the C language. Also, the simulator connects the analogue circuit blocks coded into a C language to each other, thereby implementing an inner delay and a signal flow between the analogue circuit blocks to be similar to those of a substantial analogue circuit.

The simulator interconnects the digital circuit block coded into an HDL PLI and the analogue circuit block coded into a C language thereby to perform a simulation, and thus outputs a result similar to a transistor level.

A simulation by the HDL PLI and a C compiler is performed faster than a simulation by a simulation program with integrated circuit emphasis (SPICE) due to a fast calculation speed.

Hereinafter, a result obtained by simulating the inverting amplifier, the analogue circuit by using the analogue circuit block in a circuit design will be explained.

FIG. 6 is a circuit diagram showing a construction of the inverting amplifier.

The inverting amplifier is the most basic block in an analogue circuit design, and is the most frequently used. The inverting amplifier inverts two input voltages by amplifying as much as a resistance ratio between an input terminal and an output terminal and thereby outputs the voltages. A characteristic of the inverting amplifier can be expressed as follows.
V₀=−(v₁*r₃/r₁+v₂*r₃/r₂)

The inverting amplifier has a resistance value to be applied to a substantial electronic circuit, and an output gain is determined according to the resistance value. The simulator implements the hardware transfer function expressed as a formula into a C language, constitutes the analogue circuit block with the implemented C language, and performs a simulation by reading the C language. For instance, an output characteristic of the coded C language of the inverting amplifier is expressed as a formula with consideration of an electronic characteristic.

A comparison between a simulation result by the simulator and a simulation result by an analogue design tool using a SPICE will be explained as follows.

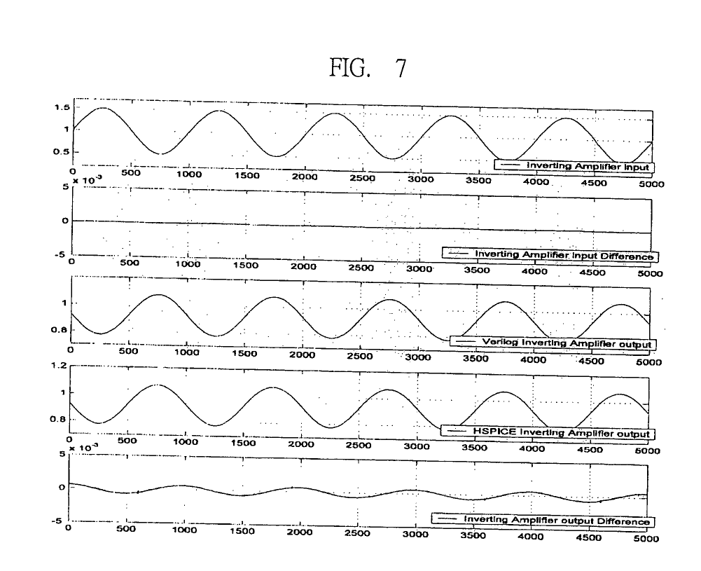

FIG. 7 is an exemplary view showing each simulation result by a simulator and an analogue design tool.

Referring to FIG. 7, the first graph shows input values by the analogue design tool and the simulator. An input difference between the analogue design tool and the simulator inputs is ‘O’ as shown in the second graph.

The third and fourth graphs show output values by the analogue design tool and the simulator. An output difference between the analogue design tool and the simulator is approximately 10⁻⁴, which is very small as shown in the fifth graph.

The simulation time (1.3 seconds) of the simulator corresponds to 1/11 of the simulation time (16.47 seconds) of the analogue design tool. As the number of devices in the analogue design tool is increased, the simulation time is increased. Therefore, when a relatively large circuit is simulated by the simulator, a designing time is reduced.

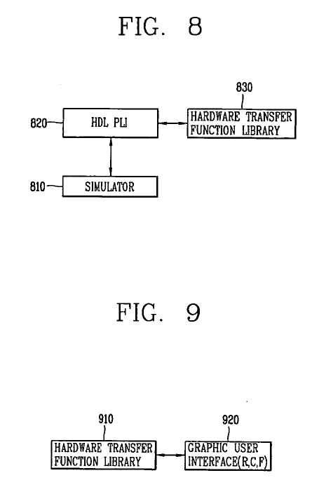

FIG. 8 is an exemplary view showing a linked construction of a hardware transfer function library to be coded into a C language in the simulator according to the present invention.

A simulator 810 enhances a processing speed for simulating the analogue circuit block and the digital circuit block by an interface by linking a hardware transfer function library 830. The hardware transfer function library 830 provides an analogue circuit block coded into a C language. The simulator 810 registers an analogue circuit block declared as a PLI API library routine in a language construct coded into an HDL PLI 820 into a system task by linking the hardware transfer function library 830 and by referring to the hardware transfer function library 830. The simulator 810 calculates a hardware transfer function included in the analogue circuit block, that is, a user program routine when the system task is executed.

FIG. 9 is an exemplary view showing a construction of a graphic user interface (GUI) 920 for adjusting a parameter that influences on an electron circuit characteristic included in a hardware transfer function library 910 according to the present invention.

The hardware transfer function comprises a parameter that influences on an electronic circuit characteristic. The parameter comprises a resistance, a capacitor, or a frequency. For example, an output gain of the inverting amplifier is determined according to a resistance value, and an integration constant of the integrator is determined according to a resistance value, a capacitor value, and a frequency value. Accordingly, parameters such as a resistance, a capacitor, or a frequency that influences on an electronic circuit characteristic in the analogue circuit block have to be adjusted in correspondence to a characteristic of a circuit to be applied to the transistor level design.

A graphic user interface 920 searches an analogue circuit block included in the hardware transfer function library 910, and outputs parameters coded into a C language, that is, a resistance value, a capacitor value, or a frequency value to the searched analogue circuit block. The graphic user interface 920 updates the outputted resistance value, the capacitor value, or the frequency value coded into a C language in the corresponding analogue circuit block of the hardware transfer function library by receiving a resistance value, a capacitor value, or a frequency value corresponding to the searched analogue circuit block.

The simulator links the updated hardware transfer function library 910 thereby to apply it to simulate the analogue circuit block.

As aforementioned, in the present invention, an electronic characteristic of an analogue circuit is coded into an upper level language, and the upper level language is read by a behavioral block by a digital design tool. Then, the read language is interfaced with a different digital circuit thus to be simulated, and thereby a simulation result similar to a transistor level is outputted. The analogue transistor level circuit can be precisely verified by using the outputted simulation result.

Furthermore, since a simulation result by the digital tool is almost equal to a simulation result by the analogue design tool, a capacitor value and a resistance value obtained by coding the electronic characteristic of the analogue circuit into a C language in the digital design tool is applied to the analogue design tool. Accordingly, the number of times that simulations are performed in the analogue design tool is decreased thereby to reduce the entire design time.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A system for simulating an electronic characteristic of an analogue circuit, comprising a processor operated by a program for instructing a command to convert a hardware transfer function of an analogue circuit into a program language of a hardware description language program language interface (HDL PLI) in order to design a transistor level with consideration of an electronic characteristic of the analogue circuit.

2. The system of claim 1, wherein the program language is a C program language code.

3. The system of claim 1, wherein the program comprises a hardware transfer function library for providing a plurality of analogue circuits implemented as the hardware transfer function of the analogue circuit is coded into a program language.

4. The system of claim 1, wherein the program comprises a graphic user interface for adjusting a parameter to influence on an electronic circuit characteristic of the hardware transfer function.

5. The system of claim 4, wherein the parameter comprises a resistance value, a capacitor value, or a frequency value.

6. The system of claim 1, wherein the program is applied by all types of simulators.

7. A method for simulating an electronic characteristic of an analogue circuit in a transistor level design with consideration of an electronic characteristic of an analogue circuit block, the method comprising:
converting a hardware transfer function of the analogue circuit block into a program language of a hardware description language program language interface; and
simulating the hardware transfer function of the analogue circuit block converted into the program language.

8. The method of claim 7, wherein the program language is a C program language code.

9. The method of claim 7, wherein the step of converting comprises:
a circuit search step for receiving an equation for a circuit and searching an analogue circuit to be implemented from the inputted equation in a behavioral level design corresponding to the transistor level design;
a function search step for searching a hardware transfer function suitable for the searched analogue circuit; and
a language convert step for converting the searched hardware transfer function to a program language of a program language interface.

10. The method of claim 9, wherein the function search step comprises:
constituting a hardware transfer function library for providing a plurality of analogue circuits implemented as the hardware transfer function of the analogue circuit is coded into a program language interface; and
searching a hardware transfer function suitable for an analogue circuit in the hardware transfer function library.

11. The method of claim 7, wherein the step of converting comprises:
constituting a graphic user interface similar to a hardware transfer function of the analogue circuit; and
adjusting the hardware transfer function of the analogue circuit by the graphic user interface.

12. In a transistor level design with consideration of an electronic characteristic of an analogue circuit block, a system for simulating an electronic characteristic of an analogue circuit, comprising:
a converting unit for converting a hardware transfer function of the analogue circuit block into a program language of a hardware description language program language interface; and
a processing unit for executing a program including a simulation unit for simulating the hardware transfer function of the analogue circuit block converted into the program language.

13. The system of claim 12, wherein the program language is a C program language code.

14. The system of claim 12, wherein the program comprises a hardware transfer function library for providing a plurality of analogue circuits implemented as the hardware transfer function of the analogue circuit is coded into a program language.

15. The system of claim 12, wherein the program comprises a graphic user interface for adjusting an electronic circuit characteristic of the hardware transfer function.

16. The system of claim 15, wherein the parameter comprises a resistance value, a capacitor value, and a frequency value.

17. The system of claim 12, wherein the program is executed by all types of simulators.
